(19) United States
(12) Patent Application Publication
(10) Pub. No.: US 2022/0168933 A1
(43) Pub. Date: Jun. 2, 2022

(54) METHOD FOR PRODUCING A COMPONENT

(71) Applicant: FRIMO GROUP GMBH, Lotte (DE)

(72) Inventor: Rainer Janotta, Bissendorf (DE)

(73) Assignee: FRIMO GROUP GMBH, Lotte (DE)

(21) Appl. No.: 17/612,683

(22) PCT Filed: May 19, 2020
(86) PCT No.: PCT/EP2020/064009

§ 371 Date: Feb. 11, 2022

(30) Foreign Application Priority Data
May 20, 2019 (DE) 10 2019 207 338.7

(51) Int. Cl. B29C 45/14; B29C 44/12; B29C 45/26; B29C 45/27

(52) U.S. Cl. CPC B29C 45/14418; B29C 45/14344; B29C 2037/0035; B29C 45/2669; B29C 45/27; B29C 44/1271

(57) ABSTRACT

The invention relates to a method for producing a component, said method comprising the steps of: providing a dimensionally stable carrier which comprises a first through-opening and a second through-opening; attaching the dimensionally stable carrier to a first mould half, wherein a sprue cavity is formed in the region of the first through-opening on the side of the dimensionally stable carrier facing the first mould half and an overflow chamber is formed in the region of the second through-opening; positioning a second mould half such that a cavity connecting the first through-opening and the second through-opening is formed at least in sections between the second mould half and the dimensionally stable carrier, and introducing a material into the sprue cavity.

### TECHNICAL FIELD

The invention relates to a method for producing a component comprising at least two sections, which component can be used, for example, as an (interior) cladding component for an automobile or the like. In particular, a first section should be formed as a dimensionally stable carrier that is produced, for example, by means of an injection moulding process. The second section is attached to the first section by means of a casting process.

### PRIOR ART

For the production of a component comprising a first section produced by means of injection moulding and a second section, a sprue system is required with which the material to be introduced for the second section (for example polyurethane) is supplied, as well as an overflow, with which the air in the tool cavity which is displaced as the material for the second section is introduced can be collected.

Both the sprue system and the overflow are prepared in advance during production of the first section. Certain regions of the first section of the component are formed accordingly for this purpose. These regions must be removed by trimming once the second section has been attached to the first section of the component so as not to spoil the visual appearance of the component. In this process, in addition to a further method step, the corresponding loss of material must be considered.

### SUBJECT MATTER OF THE INVENTION

An object of the present invention is to simplify or entirely avoid post-processing when producing a component comprising a first and a second section.

The invention provides a method for this purpose. Further preferred embodiments are specified in the dependent claims.

In particular, the invention is based on the realisation that, in order to avoid trimming, a so-called off-tool component must be produced. It is preferable in this regard that a sprue system for introducing the material for the second section of the component and an overflow for ventilation when producing the second section be provided on a rear side of the component. The rear side refers to the region which is not visible once the component has been produced. The sprue system and the overflow can therefore both remain on the component and there is no longer any need for trimming. Thus, the visual appearance of the component is not spoiled.

The invention provides a method for producing a component, said method comprising the following steps: providing a dimensionally stable carrier which comprises a first through-opening and a second through-opening; attaching the dimensionally stable carrier to a first mould half, wherein a sprue cavity is formed in the region of the first through-opening on the side of the dimensionally stable carrier facing the first mould half and an overflow chamber is formed in the region of the second through-opening; positioning a second mould half such that a cavity connecting the first through-opening and the second through-opening is formed at least in sections between the second mould half and the dimensionally stable carrier, and introducing a material into the sprue cavity. It is preferred that the steps be carried out in the aforementioned order.

The material introduced into the sprue cavity is preferably a thermosetting material.

In a preferred embodiment, it is provided that the material introduced into the sprue cavity is a polyurethane material, in particular a polyurethane varnish or a polyurethane foam material. A smooth or soft surface, for example, can thus be produced.

It is preferred that the polyurethane material be mixed from at least two components in a mixing head before being introduced into the sprue cavity. The polyurethane material is thus mixed shortly before being introduced into the sprue cavity.

In a further embodiment, it is provided that the dimensionally stable carrier is an injection-moulded component. Such an injection-moulded component enables a multitude of shaping options such that the component can be used as an interior cladding component, for example.

A further variant of the method is directed at the fact that the material introduced into the sprue cavity and/or the overflow chamber remains on the component. Trimming the component is not required, and thus there is no longer any need for a post-processing step, and any corresponding material loss can be avoided.

The component can be released, and thus removed, from the first mould half by means of an ejector pin or a plurality of ejector pins after an at least partial hardening of the material.

The dimensionally stable carrier, on the side facing the first mould half, may comprise a surrounding seal around the sprue cavity and/or a surrounding seal around the overflow chamber. Thus, the material, which is preferably a polyurethane material, remains in a defined region on the dimensionally stable carrier. Handling is made easier since the dimensionally stable carrier itself comprises the seal.

The dimensionally stable carrier may comprise a textured surface in sections on the side facing the second mould half, which is the visible side of the component. The visual appearance of the component is thus enhanced in regions which are not covered by the material (preferably polyurethane material).

The dimensionally stable carrier may have a different colour to the material so that the whole appearance of the component can be adapted to a certain design.

The component is preferred to be a (decorative) cladding component (for example for use on or in a vehicle), preferably an interior cladding component, in particular a vehicle interior cladding component. The method described is particularly suitable for such components which call for a high level of design freedom and are required in large quantities.

The invention further relates to a component. This component can preferably be produced by means of a method according to one of the preceding claims. The component comprises: a dimensionally stable carrier (for example an injection-moulded component) and a material (preferably a polyurethane material) attached to a front side of said dimensionally stable carrier by means of a casting process, with a sprue region and an overflow region being provided on a rear side of the component.

### BRIEF DESCRIPTION OF THE DRAWINGS

FIG. 1 is a cross-sectional view of a device with a mixing head for providing a polyurethane material.

FIG. 2 is a detailed view depicting a sprue system for introducing the polyurethane mixture.

FIG. 3 is a detailed view depicting the overflow.

FIG. 4a shows a front side of a component comprising two sections.

FIG. 4b shows a rear side of the component depicted in FIG. 4a.

### DETAILED DESCRIPTION OF THE PREFERRED EMBODIMENTS

In the following, a preferred embodiment of the invention will be described with reference to the enclosed figures. Further modifications of certain individual features mentioned in this context can each be combined with one another to form new embodiments. Although the embodiment described below is to be understood purely as an example, individual features can also be used to specify the invention.

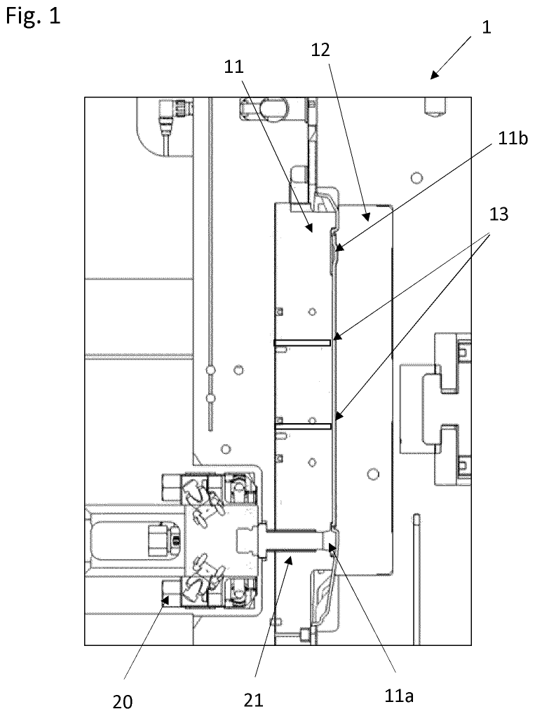

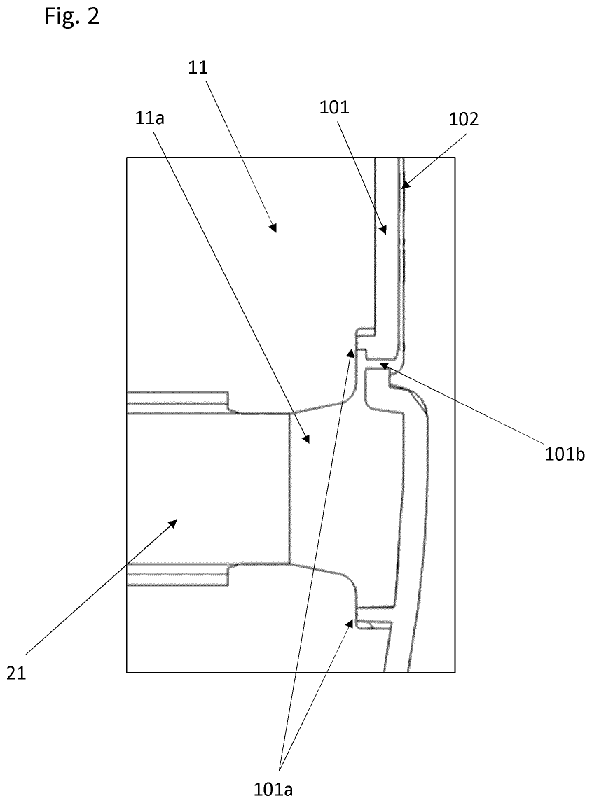

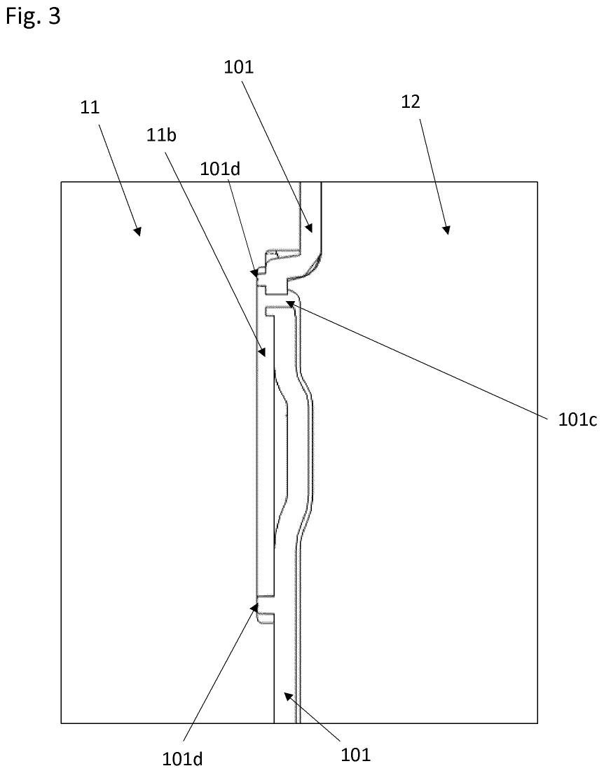

FIG. 1 shows a cross-section of part of a device 1, which is used for producing a second section on an already existing first section of a component. With such a device, a dimensionally stable carrier (first section of the component) produced by means of injection moulding is provided with a polyurethane varnish or a deformable polyurethane surface, for example.

Device 1 comprises an immovable first mould half 11 and a second mould half 12 which is movable relative to the first mould half 11. The first mould half 11 is suitable for accommodating the dimensionally stable carrier (also referred to hereinafter as injection moulded carrier) 101, which constitutes the first section of the component.

A plurality of ejector pins 13, which are used to push the component out of the first mould half 11, are inserted in the first mould half 11 so that the component can be removed from the first mould half 11.

In the region of the first mould half 11, a mixing head 20 is also provided, which is configured to mix components so as to produce a reactive polyurethane material and to introduce said components into a region between the first mould half 11 and the second mould half 12. In particular, the starting components are injected at high pressure into a mixing chamber of the mixing head, are mixed together, and are caused to chemically react. For example, a polyol and isocyanate, in particular di-isocyanate, are injected into the mixing chamber and mixed therein. The polyurethane material is subsequently discharged from a nozzle 21 of the mixing head 20 into the region between the first mould half 11 and the second mould half 12.

Device 1 is depicted in the figures with an injection-moulded component 101 inserted therein. In the region of the nozzle 21 of the mixing head 20, the injection-moulded component 101 comprises a first surrounding seal 101a configured to form a sealed area between the injection-moulded component 101 and the first mould half 11. A sprue cavity 11a located in the sealed area between the nozzle 21 and the injection-moulded component 101 constitutes a part of the sprue system.

The injection-moulded component 101 further comprises a first through-opening 101b in the injection-moulded component 101 attached to the first mould half 11, which through-opening is arranged close to the nozzle 21 of the mixing head 20. The dimensions of the first through-opening 101b are such that a polyurethane material discharged by the nozzle 21 can pass therethrough. After passing through the first through-opening 101b, the polyurethane material can enter a cavity formed between the second mould half 12 and the injection-moulded component 101 on the visible side of the component.

In another region of the injection-moulded component 101, a second through-opening 101c is provided, the dimensions of which are such that the polyurethane material introduced into the cavity between the second mould half 12 and the injection-moulded component 101 can reach the side of the injection-moulded component 101 facing the first mould half 11. A region facing between the injection-moulded component 101 and first mould half 11 provides an overflow chamber 11b.

Like the sprue cavity 11a, the overflow chamber 11b is provided on the rear side of the injection-moulded component 101. In order to seal the overflow chamber 11b relative to the first mould half 11, a second surrounding seal 101d is formed on the injection-moulded component 101, said seal coming into contact with the first mould half 10 when the injection-moulded component 101 is placed on the first mould half 11 and closing the overflow chamber 11b when the tool is closed.

The following is a description of a method for producing a component comprising a first section and a second section.

Firstly, the injection-moulded component 101 is placed on or attached to the first mould half 11 such that the injection-moulded component 101 is held by the first mould half 11. Then, the second mould half 12 is moved in the direction of the first mould half 11 and device 1 is closed thereby. The injection-moulded component 101 is clamped in this state between the mould halves of the device, whereby a cavity is formed in sections on the side of the injection-moulded component 101 facing the second mould half (the visible side). This cavity is to be filled with a polyurethane material.

When device 1 is closed, the mixing head 20 is activated. The starting components are injected at high pressure into the mixing chamber of the mixing head 20, mixed together and caused to chemically react, and the polyurethane material is injected from the nozzle 21 of the mixing head 20 into the sprue cavity 11a. From there, the polyurethane material passes through the first through-opening 101b in the injection-moulded component 101, fills the cavity 102 between the injection-moulded component 101 and the second mould half 12, and passes through the second through-opening 101c into the overflow chamber 11b.

Once the polyurethane material has at least partially hardened, device 1 is opened by moving the second mould half 12. The ejector pins 13 push the component produced in this way out of the first mould half 11 so that the component can be removed or so that it falls out of the first mould half.

Although the embodiment example mentions one sprue cavity 11a and one overflow chamber 11b, a plurality of sprue cavities 11a and/or a plurality of overflow chambers 11b may also be provided in other embodiments.

In the embodiment, an injection-moulded component 101 attached to the first mould half 11 is described. Instead of being formed as an injection-moulded component 101, the dimensionally stable carrier may also be formed differently, for example as a component made of a fibre composite material.

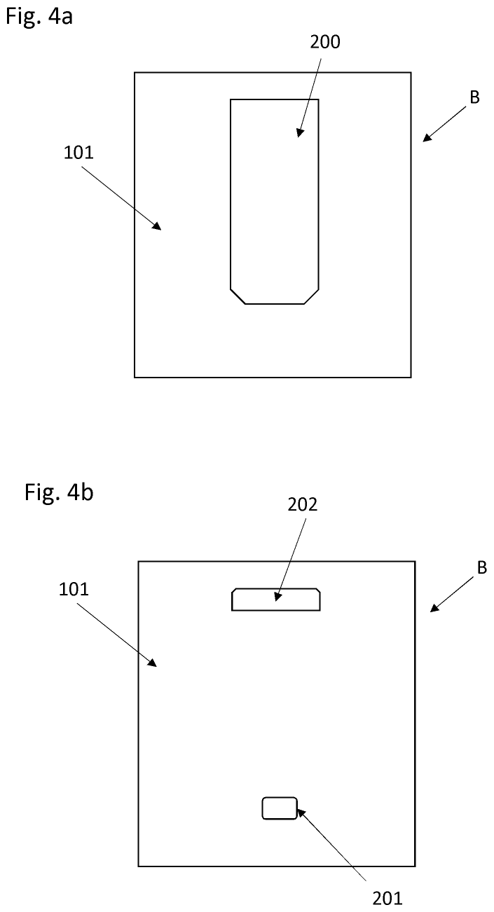

FIG. 4a shows a front side (visible side) of a component B produced by the method described above. The component comprises the injection-moulded component 101, which is provided with a structure and accommodates a region 200 of polyurethane material 200 (second section of the component) on a centrally-located surface region.

FIG. 4b shows the rear side of the component depicted in FIG. 4a. The region 201 (sprue region) formed by the cavity 11a during the production of the component is provided on component B with the polyurethane material 200. The same is also true for a region 202 (overflow region) on component B, which is defined by the overflow chamber 11b during the production of component B.

Since the regions 201 and 202 are located on the rear side of the component B and are therefore not visible when component B is in use as an interior cladding component of an automobile, the regions 201 and 202 comprising the polyurethane material can remain on the component B.

1. A method for producing a component, the method comprising acts of:
providing a dimensionally stable carrier which comprises a first through-opening and a second through-opening,
attaching said dimensionally stable carrier to a first mould half, wherein a sprue cavity is formed in the region of the first through-opening on the side of the dimensionally stable carrier facing the first mould half and an overflow chamber is formed in the region of the second through-opening,
positioning a second mould half such that a cavity connecting the first through-opening and the second through-opening is formed at least in sections between the second mould half and the dimensionally stable carrier, and
introducing a material into the sprue cavity.

2. The method according to claim 1, wherein the material introduced into the sprue cavity is a thermosetting material.

3. The method according to claim 1 wherein the material introduced into the sprue cavity is a polyurethane material.

4. The method according to claim 3, wherein the polyurethane material is mixed from at least two components in a mixing head before being introduced into the sprue cavity.

5. The method according to claim 1, wherein the dimensionally stable carrier is an injection-moulded component.

6. The method according to claim 1, wherein the material introduced into the sprue cavity and/or the overflow chamber remains on the component.

7. The method according to claim 1, wherein the component is released from the first mould half by means of an ejector pin or a plurality of ejector pins after an at least partial hardening of the material.

8. The method according to claim 1, wherein, on the side facing the first mould half, the dimensionally stable carrier comprises a surrounding seal around the sprue cavity and/or comprises a surrounding seal around the overflow chamber.

9. The method according to claim 1, wherein the dimensionally stable carrier comprises a textured surface in sections on the side facing the second mould half.

10. The method according to claim 1, wherein the dimensionally stable carrier has a different colour to the material.

11. The method according to claim 1, wherein the component is a cladding component.

12. A component produced by a method according to claim 1, the component comprising a dimensionally stable carrier and a material attached to said dimensionally stable carrier on a front side using a casting process, wherein a sprue region and an overflow region are provided on a rear side of said component.

13. The method according to claim 1, wherein the polyurethane material is a polyurethane varnish or a polyurethane foam material.

14. The method according to claim 11, wherein the cladding component is a vehicle interior cladding component.
